(19) United States
(12) Patent Application Publication
(10) Pub. No.: US 2011/0246026 A1
(43) Pub. Date: Oct. 6, 2011

(54) VEHICLE CONSOLE CONTROL SYSTEM

(76) Inventor: Gary Stephen Shuster, Fresno, CA (US)

(21) Appl. No.: 13/079,667

(22) Filed: Apr. 4, 2011

Related U.S. Application Data
(60) Provisional application No. 61/320,616, filed on Apr. 2, 2010.

(51) Int. Cl. G06F 7/00

(52) U.S. Cl. 701/36

(57) ABSTRACT

A control system for an interactive vehicle console disables certain interactive functions in response to a signal indicating that the vehicle is in motion, and in addition, permits a passenger to bypass the disablement feature using one or more input devices. An input device may include a transmitter/receiver system that transmits a signal from the passenger seat via the passenger's body to an input device on the vehicle console. A low-frequency electrical signal may be transmitted from a transmitter in the seat cushion to a touchscreen or button on the console, when the passenger touches the screen or button. In response to detecting the low-frequency signal, the console control may enable a feature of the console that it has disabled because of vehicle motion. In other embodiments, the input device may comprise a vision system that determines the source of command input from camera input taken of the driver and passenger.

### CROSS-REFERENCE TO RELATED APPLICATION

This application claims priority pursuant to 35 U.S.C. §119(e) to U.S. provisional application Ser. No. 61/320,616, filed Apr. 2, 2010, which application is specifically incorporated herein, in its entirety, by reference.

### BACKGROUND

1. Field

The present disclosure relates to a vehicle console control feature, and more particularly, to methods and apparatus for enabling console operation responsive to user position in the vehicle.

2. Description of Related Art

Current vehicle console control systems disable selected console functions in response to a signal indicating that the vehicle is in motion. For example, GPS navigation functions provided via an interactive display screen in a vehicle front console may be disabled when the vehicle is in motion, to prevent the driver from attempting to use the function while driving the vehicle. This control feature prevents the driver from undue distractions while driving, but also prevents passengers from using the disabled feature, even though the passenger can safely use the disabled feature while the driver drives. Therefore, the motion-disabling feature may sometimes lead the driver to take unnecessary risks, such as, for example, the risk of pulling over on the side of the road or exiting a freeway unnecessarily to stop the vehicle and access the disabled feature.

Passenger occupancy sensor systems are known, to enable console operation in response to detecting that the front passenger seat is occupied, even while the vehicle is in motion. However, vehicle seat occupancy sensing systems may be too easily defeated. The driver is still able to access features that should be disabled while the vehicle is in motion, so long as the passenger seat is occupied by an actual person or by some heavy object. Seatbelt sensors or infrared sensors are not so easily defeated using an inanimate passenger, but entail additional cost and complexity without preventing unsafe use by a driver while an actual passenger is present. Biometric sensors, such as fingerprint sensors, may be used, but are also subject to being defeated by the driver so long as the biometric entry device is in reach or otherwise accessible while the vehicle is in motion. In addition, biometric sensors also add cost and complexity, and more importantly, considerable inconvenience for the user. Thus, biometric based control is unlikely to be voluntarily adopted. Touch angle sensors have been proposed to detect a direction of physical input, but such sensors might either be easily defeated by anyone with adequate reach and flexibility, or require inconvenient or redundant placement of user input controls, both of which are undesirable.

It would be desirable, therefore, to provide a vehicle console control system that overcame these and other limitations or disadvantages of the prior art.

### SUMMARY

The present disclosure presents a control method, system and apparatus for a vehicle information console that operates to disable certain functions for the driver while the vehicle is moving, while enabling those functions for the passenger. In another aspect, the system may alter operation of a console electronic device in response to sensor input indicating a position of the user providing the input. The system or apparatus may include technical features that permit discrimination between input received from a driver, and input received from a passenger.

In an aspect of the disclosed technology, a method for controlling an electronic device in a vehicle console may include receiving input at an electrical device in a vehicle console from a user located inside the vehicle. The input may include, for example, tactile input at a keypad or touchscreen, or audible input in the form of spoken commands. The method may further include determining a position of the user in the vehicle, using an electrical circuit in communication with the electrical device. Determining the position in the vehicle may include determining which seat in the vehicle that the person providing the input is occupying. The determination may be a positive determination, and not merely a coincidence of events such as receiving input at a time when a sensor indicates a particular seat is occupied. In contrast, a positive determination include determining that input is received from the person actually occupying the particular seat, which a high degree of likelihood. The electrical circuit should make the determination in a manner that is convenient and unnoticeable to the user, of which several examples are provided in the disclosure that follows.

The method may include altering an operation of the electronic device in response to the position of the user as determined using the electrical circuit. Altering may include disabling a function of the electronic device, enabling a disabled feature, or modifying operation of a feature. While the primary examples discussed herein concern enabling a feature in response to detecting that input comes from a person occupying a passenger seat, it should be appreciated that one or more features may also be enabled, disabled, or modified in response to detecting that input comes from a person occupying the driver's seat, for certain applications.

In an aspect, the method may include determining the position of the user by capturing an image of the user, and analyzing the image. In another aspect, the method may include determining the position of the user by sensing a direction of an audible command from the user. In another aspect, the method may include determining the position of the user by detecting a signal from a signal generator. In such aspect, the method may include transmitting the signal to a detector coupled to a user interface for the electrical device. The method may include transmitting the signal to the user interface through at least a portion of the user's body, for example through a user's trunk, arm and finger. In such case, the method may include transmitting the signal through a portion of a vehicle seat configured to couple electrically to the user's body.

In an aspect, the method may include encoding data in the signal. This may be useful, for example, when it is desired to distinguish between input coming from different seat positions in the vehicle. A different code may be encoded in the signal to indicate different seat positions. In another aspect, the method may include detecting the signal using the detector comprising a thin conductive membrane over the user interface.

In another aspect of the disclosed technology, a system for controlling an electronic device in a vehicle console may include a user interface device in a vehicle console, for example, a keypad or touchscreen interface. The system may further include an electrical circuit in communication with the electrical device, configured for determining a position of a user inside a vehicle. As noted above, the position relates to which vehicle seat a user providing input to the user interface device is occupying. The system may further include an electronic device coupled to the user interface device, configured for altering operation of the electronic device in response to a signal from the electrical circuit indicating the position of the user inside the vehicle. As noted above, altering may include enabling, disabling or modifying a feature of the electronic device.

In an aspect, the electrical circuit may include a camera. The electrical circuit may include a processor configured to analyze at least one image of the user taken by the camera to determine the position of the user.

In another aspect, the electrical circuit may include a signal generator. The signal generator may be coupled to a vehicle seat for the user, for transmitting a signal through a user's body. A signal coupler device may be incorporated in a material of the vehicle seat, for coupling the signal generator to the user's body. The signal coupler device may include a conductive material incorporated into a seat cover. In another aspect, the signal generator may be coupled to transmit the signal from a vehicle seat and through the user's body in any suitable fashion. When encoded data is included in the signal, the system may include a decoder for decoding information from the signal indicating a position of the user.

A sensor may be coupled to the user interface for detecting a signal from the signal generator. The sensor may include a thin transparent conductive membrane disposed over at least a portion of the user interface. In the alternative, the sensor may comprise a conductive key cover disposed over at least a portion of the user interface.

### BRIEF DESCRIPTION OF THE DRAWINGS

FIG. 1 is a block diagram showing an example of a system 100 that may be used to discriminate between input from a vehicle driver and input from a front-seat passenger, and control console functionality in response to such input.

FIG. 2 is a flow chart showing an example of a method that may be performed using the system 100, or a similar system.

FIG. 3 is a block diagram showing an example of a source detection system for a vehicle control panel that uses an electrical signal transmitted through the passenger body to a receiver.

### DESCRIPTION

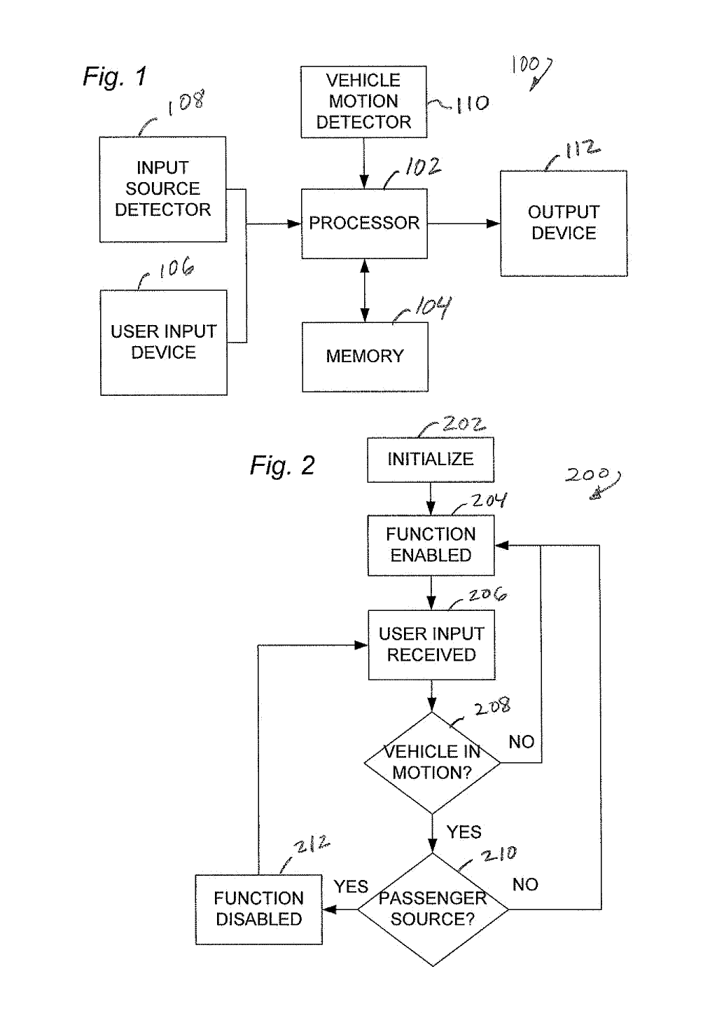

FIG. 1 is a block diagram showing an example of a system 100 that may be used to discriminate between input from a vehicle driver and input from a front-seat passenger, and control console functionality in response to such input. System 100 may be installed in a vehicle, for example, a passenger car or truck. The system may comprise a processor 102 coupled to a memory 104 holding program instructions for the processor and data. The processor may receive data input from a user input device installed in the vehicle, for example, a touchscreen interface, keypad, or both. The input device 106 may be positioned in the vehicle at a location where it is accessible to both the passenger and to the driver, for example, at or near the central dashboard.

The processor may further receive input from an input source detector 108. The input source detector may provide a signal to the processor, indicating whether or not input received from the user input device 106 is originating from, or likely to be originating from, the passenger. The sensor input may indicate a position of the person providing the input in the vehicle; for example, whether the person is occupying a passenger seat or a driver's seat.

Various types of input source detectors may be used is system 100 to provide a source indication signal to processor 102. In some embodiments, the input source detector may comprise a button or other input device placed out of reach of the driver, but within reach of the passenger, and coupled to the processor via an appropriate signaling interface. When the button or other input device is activated, for example, being held down by the passenger's foot, the source detector may provide a signal to the processor to indicate that the passenger is providing input at the passenger-only accessible input device while input is also being received at the user input device 106, which is accessible to both the passenger and driver. However, the foregoing configurations are not capable of indicating the source of input received at the input device 106, only that a passenger is present or actively engaged while the input is being received.

Accordingly, the user input device 106 and the input source detector 108 may be configured and coupled in a way that enables indicating whether or not the input being received at the input device is actually coming from a person sitting in the passenger seat, or from a person sitting in the driver's seat. Various examples of such configurations are provided below. For example, where tactile input is being received, the finger or other body part providing the tactile input may carry a current or other electrical signal transmitted by a transmitter located in or near the passenger seat. Conversely, the signal may be transmitted from the driver's seat to indicate that the tactile input is originating from the driver. The current or other signal should be weak enough so that it is not perceptible to the person whose body it is transmitted through, while being strong enough to be detected by the source detector 108. Optionally, the signal may be in the form of a low-frequency digital signal, and may encode information encoded by an encoder circuit prior to transmission. For example, the source detection signal may encode information from a sensor in the passenger seat, or a predetermined encoded value.

For further example, a microphone input device may 106 may be coupled with a source detector 108 that operates by determining the originating location for voice commands, such as by using data from multiple input microphones to determine the originating location. Such a system may readily differentiate between sound from the driver's side of the vehicle and sound from the passenger's side. Another example of an input source detector for tactile input is one that operates by detecting the direction of arm extension using a vision system. In a vehicle where the driver and passenger sit on opposite sides of the input device 106 that is in the center console, the source detector 108 may use a visual indication of an arm extending from the driver's side to the input device to signal that input is coming from the driver, and a visual indication of an arm extending from the passenger's side to the input device to signal that input is coming from the passenger.

The processor 102 may further be coupled to receive input from a vehicle motion detector 110, for example, a vehicle speedometer system. In response to inputs from the input device 106, source detector 108 and motion detector 110, the processor may control data output to the output device 112, for example, to a display screen or audio output device. FIG. 2 is a flow chart showing an example of a method that may be performed using the system 100, or a similar system. Method 200 may be implemented using program instructions encoded in processor memory 104. When the system is powered up, for example in response to vehicle ignition, the processor may initialize 202 by loading the required programming; resetting variables and performing a status check of critical system components. When ready, the processor may enable the function 204 to be conditionally restricted depending on vehicle motion and input source. Any function may be selected as subject to restriction, but such functions are generally ones that are either prohibited by law while driving, or are believed to be overly distracting while driving.

Conditional response may be triggered in response to receiving command input 206 from the user input device 106. At 208, the processor may determine whether or not the vehicle is in motion using data from the vehicle motion detector 110. If the processor determines that the vehicle is not in motion, the processor may maintain the function in an enabled state 204 and respond to the input in accordance with the enabled function. If processor determines that the vehicle is in motion, it may then determine the source of the command input 210, using data from the source detector 108. If the processor determines that the input is originating from the passenger, it may maintain the function in an enabled state 204 and respond to the input in accordance with the enabled function. If the processor determines that the input is originating from the driver, or is not from the passenger, the processor may disable the function. Disabling the function may comprise ignoring the input, outputting a message that the function is disabled, or both.

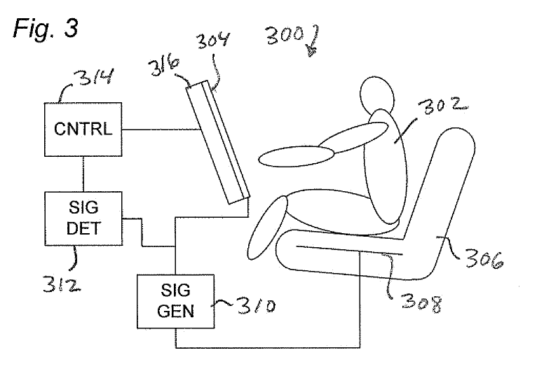

FIG. 3 is a block diagram showing an example of a source detection system 100 for a vehicle control panel that uses an electrical signal transmitted through the passenger 302 body to a receiver 304. The passenger is seated in a vehicle seat 306 that includes a transmitter 308. Transmitter 308 may include an electrically conductive material woven into the seat fabric to form a conductive array under the passenger 302, or a conductive membrane positioned over or under the seat fabric. In the alternative, or in addition, small rigid or semi-rigid conductive probes may be positioned in a supporting frame in the seat cushion, so that one or more of the probes comes in contact with the passenger's body when the cushion is depressed under the weight of the passenger's body. The probes should be relatively soft and short so that contact with the probes is not readily perceptible by the passenger, and causes no discomfort.

The transmitter 308 may be coupled to a signal generator 310 that generates an electrical signal for detection by a signal detector 312. The signal may comprise a current or a voltage transmitted through the passenger's body to a signal receiver 304 coupled to an input device 316. For example, if the input device 316 is a touchscreen, the receiver may comprise a thin transparent conductive membrane over the touchscreen, coupled to the signal detector 312. If the input device 316 is a keypad, the receiver may comprise a conductive key cover coupled to the detector. The signal may comprise encoded information such as a verification code or data from a sensor (not shown).

The controller 314, which may comprise a processor, may be coupled to the input device 316 and to the signal detector 312. The signal detector may provide a signal to the controller while detecting the signal from the signal generator, indicating to the controller that the passenger is touching the input device 316. The controller may thereby determine whether or not input from the input device 316 is originating from the passenger 302, and control operation of the vehicle console as disclosed herein.

The foregoing embodiments merely exemplify various apparatus, methods and systems for a vehicle console control system. The present technology is not limited by these examples.

What is claimed is:

1. A method for controlling an electronic device in a vehicle console, comprising:
receiving input at an electronic device in a vehicle console from a user located inside the vehicle;
determining a position of the user in the vehicle, using an electrical circuit in communication with the electronic device; and
altering an operation of the electronic device in response to the position of the user as determined using the electrical circuit.

2. The method of claim 1, further comprising determining the position of the user by capturing an image of the user, and analyzing the image.

3. The method of claim 1, further comprising determining the position of the user by sensing a direction of an audible command from the user.

4. The method of claim 1, further comprising determining the position of the user by detecting a signal from a signal generator.

5. The method of claim 4, further comprising transmitting the signal to a detector coupled to a user interface for the electrical device.

6. The method of claim 5, further comprising transmitting the signal through at least a portion of the user's body.

7. The method of claim 6, further comprising transmitting the signal through a portion of a vehicle seat configured to couple electrically to the user's body.

8. The method of claim 6, further comprising encoding data in the signal.

9. The method of claim 6, further comprising detecting the signal using the detector comprising a thin conductive membrane over the user interface.

10. A system for controlling an electronic device in a vehicle console, comprising:
a user interface device in a vehicle console;
an electrical circuit in communication with the user interface device, configured for determining a position of a user inside a vehicle; and
an electronic device coupled to receive input from the user interface device, and configured for altering operation of the electronic device in response to a signal from the electrical circuit indicating the position of the user inside the vehicle.

11. The system of claim 10, wherein the electrical circuit further comprises a camera.

12. The system of claim 11, wherein the electrical circuit further comprises a processor configured to analyze at least one image of the user taken by the camera to determine the position of the user.

13. The system of claim 10, wherein the electrical circuit further comprises a signal generator.

14. The system of claim 13, wherein the signal generator is coupled to a vehicle seat for the user, for transmitting a signal through a user's body.

15. The system of claim 14, further comprising a coupler incorporated in a material of the vehicle seat, for coupling the signal generator to the user's body.

16. The system of claim 15, wherein the coupler comprises a conductive material incorporated into a seat cover.

17. The system of claim 13, further comprising a sensor coupled to the user interface for detecting a signal from the signal generator.

18. The system of claim 17, wherein the sensor comprises a thin transparent conductive membrane disposed over the user interface.

19. The system of claim 17, wherein the sensor comprises a conductive key cover disposed over the user interface.

20. The system of claim 13, wherein the signal generator is coupled to transmit the signal from a vehicle seat through a body of the user.

21. The system of claim 20, further comprising a decoder for decoding information from the signal indicating a position of the user.
